(19) United States
(12) Patent Application Publication
(10) Pub. No.: US 2019/0006657 A1
(43) Pub. Date: Jan. 3, 2019

(54) ANODE CONTAINING DIATOM FRUSTULES

(71) Applicant: NORWEGIAN UNIVERSITY OF SCIENCE AND TECHNOLOGY (NTNU), Trondheim (NO)

(72) Inventors: Muhammad Hasanuzzaman, Trondheim (NO); Fride Vullum-Bruer, Trondheim (NO)

(21) Appl. No.: 16/062,992

(22) PCT Filed: Dec. 19, 2016
(86) PCT No.: PCT/EP2016/081769

§ 371 Date: Jun. 15, 2018

(30) Foreign Application Priority Data
Dec. 18, 2015 (GB) 1522446.2

(51) Int. Cl. H01M 4/134; H01M 4/38; H01M 4/62; H01M 4/1395

(52) U.S. Cl. CPC H01M 4/134; H01M 4/386; H01M 10/0525; H01M 4/625; H01M 4/1395; H01M 4/622

(57) ABSTRACT

A composite comprising a porous silicon dioxide network coated in a carbon coating,an electrically conducting filler such as carbon black and a water dispersible or water soluble binder, preferably an alginate binder.

This invention relates to lithium ion batteries and in particular, the anodes for such batteries. The invention relates to a composition of matter suitable for use in the anode of a lithium-ion battery, said composition comprising calcined diatoms coated in carbon, an electrically conducting filler, such as carbon black and carbon nanotubes, and a water soluble/water dispersible binder. The invention also relates to a process for the preparation of the carbon coated diatoms of use in the invention as well as to batteries comprising the anodes of the invention.

### BACKGROUND

Lithium-ion batteries are common in consumer electronics. A lithium-ion battery (sometimes Li-ion battery or LIB) is a member of a family of rechargeable battery types in which lithium ions move from the negative electrode to the positive electrode during discharge and back when charging. There are various known electrode materials for use in Li-ion batteries. Li-ion batteries often use a lithium intercalation compound as one electrode material for example. The electrolyte, which allows for ionic movement, and the two electrodes are the constituent components of a lithium-ion battery cell.

Chemistry, performance, cost and safety characteristics vary across LIB types. In order to improve battery performance, recent efforts have been placed on researching cathodes in an attempt to develop a high performing cathode but without success. Therefore, in order to have a high performance Li-ion cell, developing a high performing anode is a more realistic choice to improve the overall total cell specific capacity.

Handheld electronics mostly use LIBs based on an anode comprising graphite. Graphite has a limited theoretical capacity but is a safe material and hence favoured over other potential anode materials such as lithium metal. During charge cycle, intercalation of Li ions takes place in graphite and forms LiC₆. This process is associated with a small expansion of only about 12 vol %. The theoretical capacity associated with cycles between C and LiC₆ is 372 mAh g⁻¹.

A number of metals (i.e. Sn, Pb, Al, Ge, Zn, Cd, Ag, and Mg) which alloy with lithium and possess high specific capacity have been researched in the past decade for a possible replacement of the graphite anode. However, most of these alloys have poor cyclability due to large expansion during cycling leading to complete disintegration and loss of electronic contact with the current collector. The exception is TiO₂. Its theoretical capacity is 335 mAh g⁻¹ and thermal stability is good. However, this lithium titanium negative material operates a comparatively higher voltage (>1 V vs. Li/Li+) which leads to lower cell voltage, and therefore energy and power density suffers accordingly. Thus, the lithium titanate negative electrode drew less interest except where fast charging is vitally important.

More recently, attention has centred on silicon anodes as silicon has a very high theoretical capacity and would therefore be an ideal anode material. A Si-based anode has a theoretical specific capacity (4200 mAh g⁻¹) which is highest among the above mentioned alloying elements. The target specific capacity value of 1000-1200 mAh g⁻¹ could be easily reached by silicon-based anodes. However, the drastic volume expansion of Si anodes during cycling leads to capacity fading and pulverization and thus requires advanced treatment to make it a viable electrode in Li-ion batteries.

Expansion of 300 vol % is observed making Si anodes unsuitable for use industrially. An anode that expands by 300 vol % generates enormous mechanical stresses on the material and leads to capacity fading and subsequent pulverisation of the anode and also degradation of the solid electrolyte interphase layer which separates the current capturing part of the anode from the electrolyte.

Attempts have been made to address the issue of expansion. In US2008/0038170 a shaped Si nanoscale material which can derive from diatoms after suitable treatment is proposed. Similarly, CN102208636 takes diatomite and metallothermically reduces it to Si before coating with carbon. The idea is to use the porous diatomite structure in conjunction with the benefits of Si as an electrode but this solution still suffers from the expansion problem mentioned above.

The present inventors now explore the use of diatoms as an anode which can substitute the existing graphite based anode, providing better electrochemical performance in terms of capacity, cyclability and stability.

The high theoretical reversible specific capacity (˜1675-1965 mAh g⁻¹) and low discharge potential of silica (SiO₂) draws major interest these days as a potential replacement of Si-based anodes. Due to the higher negative electrode voltage of silica compare to graphite-based anodes, the lower cell voltage leads to the reduction of energy density. However, this energy reduction can be compensated by its very high reversible specific capacity. The combination of high voltage cathodes and composite silica anodes can boost the energy density of Li-ion batteries to the requirements of present and future day's applications.

Diatoms are single celled algae that produce a nanostructured amorphous silica skeleton called a frustule. In Energy Environ Sci 2011, 4, 3930, diatoms are identified as having potential in nanobiotechnology as they can carry metal oxides. These materials are even suggested for use in batteries, e.g. based on conversion of the frustule to Si metal. The present inventors have now realised that diatoms can be used in a high performance anode.

Diatoms are algae and are a natural source of silica (SiO₂). These algae grow a cell wall of silica called a frustule. These frustules provide natural regular nano-structured porous silica skeleton which can compensate for the expansion that occurs during cycling of the battery. The organics present in diatoms can also be used as a source of carbon-coating and reduce significant processing time and cost involved in other coating processes. Attempts to use silicon dioxide in the anodes of Li-ion batteries have been made before. In J Power Sources 196 (2011) 10240-10243, carbon coated silicon dioxide nanoparticles are proposed as an anode in Li-ion batteries. The nanoparticles used are AEROSIL particles and are heated in sucrose solution to prepare a silicon dioxide embedded in a carbon matrix. The material is not however porous.

US20140134503 describes manganese containing frustules in electrodes. The Mn acts as a coating on the frustules. It appears that the frustules are used purely as a mechanical support.

In RSC Adv. 2014, 4, 40439, diatoms covered in red algae are pyrolysed to form an anode for a Li-ion battery and used in conjunction with a PVDF/NMP binder. The biomass is not however cleaned before use and the binder employed is non aqueous/non water soluble. The combination however, of a calcined diatom and a water soluble binder is new and provides an environmentally friendly solution which has not only advantages in terms of electrode capacity but also reduced cost.

In this regard, another major problem with graphite based Li-ion battery solutions is that the binder employed in these batteries is PVDF (polyvinylidene fluoride) in combination with NMP (N-methyl-2-pyrrolidone). PVDF is not an environmentally friendly material. NMP is even less safe as it is volatile, explosive, flammable and is a reproductive toxicant. As batteries become prevalent in “green” products such as electric cars, the industry needs a different binder that is “green”. In particular, the industry seeks an aqueous binder or water soluble binder. Such a binder is not only infinitely greener but also 90% or more cheaper than the current solution.

A detailed study on lithium-ion batteries calculated that over 90% cost reduction is possible with combination of 1) less expensive binder and solvent materials and 2) less expensive electrode processing steps by switching from a NMP-soluble PVDF binder to an aqueous binder.

It has been surprisingly found that an aqueous binder is compatible with the calcined, carbon coated diatoms of the invention. In particular, algae based aqueous binders can be used to prepare the electrodes of the invention. These are compatible with the calcined diatom material and give the electrode formed increased stability during lithiation and de-lithiation.

A water soluble/dispersible binder also interacts weakly with the electrolyte which helps to build a stable solid electrolyte interface (SEI). Whilst US2014/0193712 describes the use of alginate binders in silicon based anodes their use with porous calcined silica networks is not described.

### SUMMARY OF INVENTION

Thus, viewed from one aspect the invention provides a composite comprising a porous silicon dioxide network coated in a carbon coating, an electrically conducting filler such as carbon black and a water dispersible or water soluble binder, preferably an alginate binder.

Viewed from another aspect the invention provides a composite comprising a calcined diatom silicon dioxide network coated in a carbon coating, an electrically conducting filler such as carbon black and a water dispersible or water soluble binder, preferably an alginate binder.

Viewed from another aspect the invention provides a porous silicon dioxide network coated in a carbon coating, said porous silicon dioxide network coated in a carbon coating comprising less than 1 wt % combined weight of KCl and NaCl.

Viewed from another aspect the invention provides an anode for a lithium ion battery comprising a composite as hereinbefore defined.

Viewed from another aspect the invention comprises a lithium ion battery having at least an anode, a cathode and an electrolyte, wherein the anode comprises a composite as hereinbefore defined.

Viewed from another aspect the invention provides a process for the preparation of a composite as defined herein comprising calcining a diatom source in the presence of a carbon source to obtain a calcined diatom network coated in carbon;

combining said network with an electrically conducting filler such as carbon black and a water soluble binder.

Preferably, this blend is in the form of a slurry which is cast onto a support, such as battery grade Cu to form a film thereon.

Viewed from another aspect the invention provides the product of the above process.

### Definitions

The invention relies on a porous silicon dioxide network coated in a carbon coating. This network is derived from the calcination of a diatom source in the presence of a carbon source. The terms porous silicon dioxide network and calcined diatoms are therefore used to mean the same structure herein. The network is the porous carbon coated silicon dioxide structure that results from the calcination of diatoms in an inert atmosphere at a temperature of 400 to 800° C. in the presence of a carbon source.

The term water soluble binder is used to indicate that the binder used to bind together the electrically conducting filler such as carbon black and the porous silicon dioxide network coated in a carbon coating, is water soluble and in the process for manufacture of the composite, it is capable of being used in an aqueous solution. The term water soluble defines a material which has a solubility in water of at least 1 g/L at 23° C., e.g. at least 10 g/L.

Alternatively, the binder can be considered water dispersible. By dispersible is meant that the binder can be used in an aqueous environment (e.g. a suspension, dispersion) in order to bind together the electrically conducting filler such as carbon black and the porous silicon dioxide network coated in a carbon coating.

The binder also ensures adhesion between the porous silicon dioxide network, filler and the current collector (e.g. Cu). It will be appreciated however, that to form a final anode, a drying step is used. Any water present during preparation of the anode, e.g. in a solution of binder may therefore be removed during this drying process.

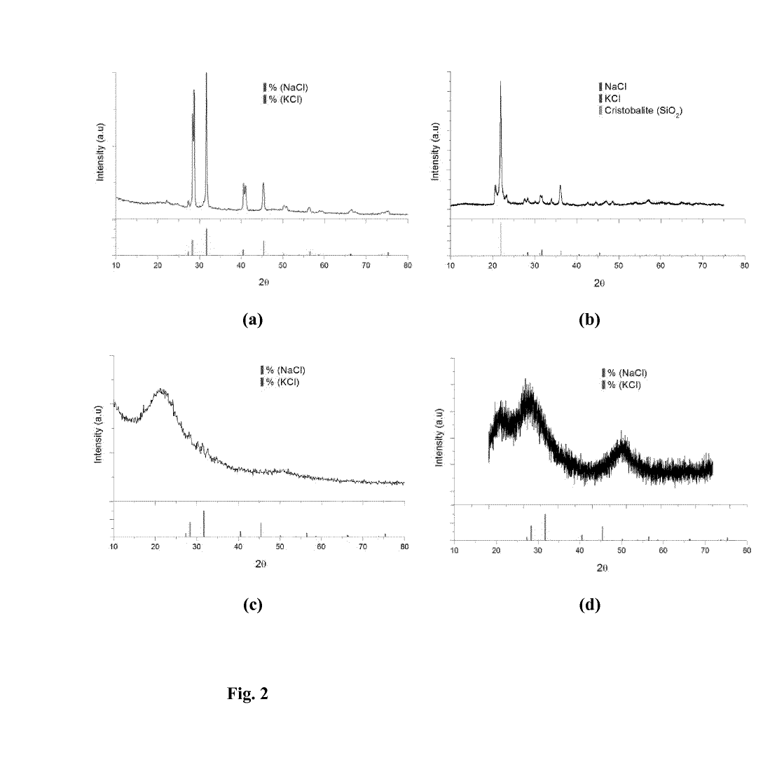

A clean or washed porous silicon dioxide network coated in a carbon coating is one which has been subjected to a cleaning process, e.g. as herein defined, to remove salts present in natural marine diatoms, in particular NaCl and KCl. A clean porous silicon dioxide network coated in a carbon coating is preferably one which is free of NaCl and KCl. By free means that the characteristic peaks associated with these compounds cannot be seen in XRD acquired as shown in FIG. 2.

### Porous Silicon Dioxide Network Coated in a Carbon Coating

The invention relies on a porous silicon dioxide network coated in a carbon coating. The silicon dioxide network is derived from the calcination of diatoms as described in further detail below in the presence of a carbon source. The term diatom is used to refer to a type of algae which has cell walls comprising of silicon dioxide. These are called frustules. There are many species of diatoms, all of which are suitable for use in the invention. Diatoms are among the most common types of phytoplankton. Diatoms are unicellular, although they can form colonies in the shape of filaments or ribbons (e.g. Fragilaria), fans (e.g. Meridion), zigzags (e.g. Tabellaria), or stars (e.g. Asterionella). A unique feature of diatom cells is that they are enclosed within a cell wall made of silica (hydrated silicon dioxide) called a frustule. These frustules show a wide diversity in form, but are usually almost bilaterally symmetrical, hence the group name.

There are more than 200 genera of living diatoms, and it is estimated that there are approximately 100,000 extant species. Diatoms are a widespread group and can be found in the oceans, in freshwater, in soils and on damp surfaces. Most live pelagically in open water, although some live as surface films or even under damp atmospheric conditions. Though usually microscopic, some species of diatoms can reach up to 2 millimetres in length.

Diatoms belong to a large group called the heterokonts, including both autotrophs (e.g., golden algae, kelp) and heterotrophs (e.g., water moulds). Their yellowish-brown chloroplasts are typical of heterokonts, having four membranes and containing pigments such as the carotenoid fucoxanthin.

The diatoms hauled from northern Norwegian Sea are disc-shaped and identified as coscinodiscus in the family of coscinodiscaceae.

It will be appreciated that the diatoms used in the invention might derive from a mixture of different species. The diatoms are harvested naturally and the make up of the diatoms will be a function of the sea from which the diatoms are harvested.

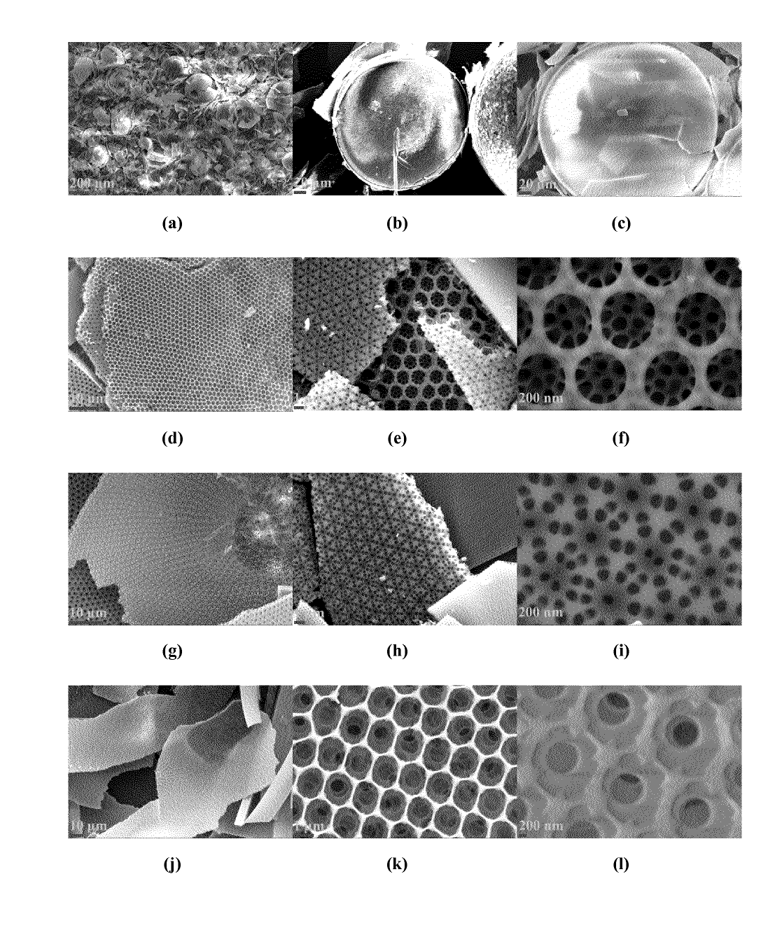

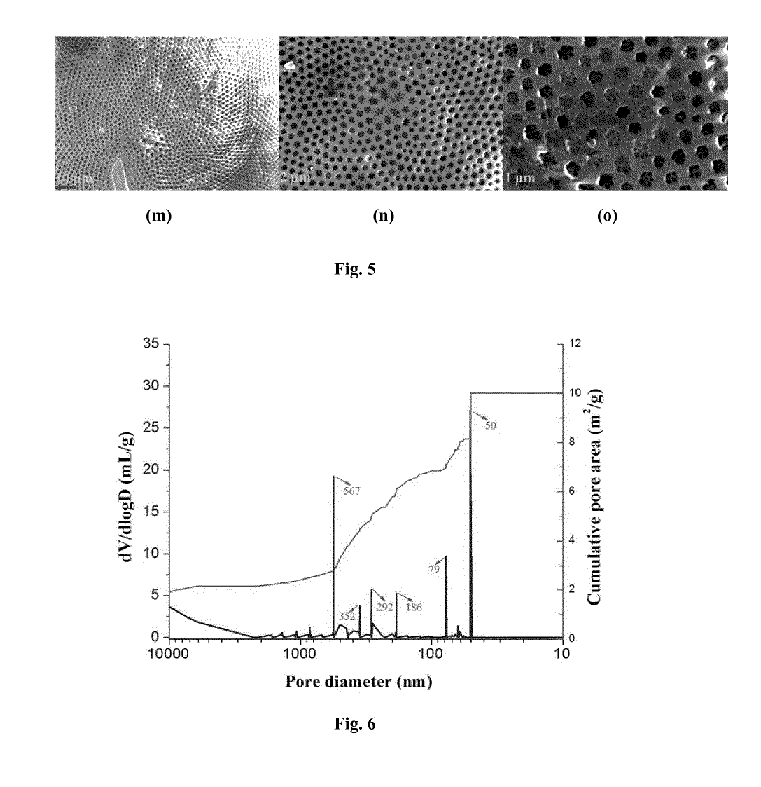

The frustules of the diatoms show a hierarchical nano or macro porous structure and this gives rise to the porous structure in the calcined diatoms. As we show in FIG. 5, the nature of the pores in the frustule vary from species to species. However, it is preferred if there are pores of less than 90 nm in size, such as in the 50-80 nm size. It is also preferred if there are pores in the 200-600 nm size range.

It is preferred if the majority of the pores are within the range of 25 to 750-nm. It will be appreciated that the calcination of the diatoms does not significantly affect the pores present. The calcination process is carried out at a temperature in an atmosphere designed not to destroy the porous nature of the frustules.

In terms of micropore surface area, it is preferred if the carbon coated diatom structure has a surface area of at least 8 m²/g, such as at least 10 m²/g. Higher surface areas are preferred. A potential upper limit is 30 m²/g.

The anode of the invention therefore relies on a porous silicon dioxide network coated in a carbon coating. That porous silicon dioxide network is derived from the calcination of diatoms. The coating is formed typically from amorphous carbon which is also formed during the calcination process from a carbon source present. Alternatively viewed therefore, the invention relates to an anode comprising the calcination product of diatoms in the presence of a carbon source.

In the rest of the application we use the term diatom to refer to the calcined diatom material that forms the porous silicon dioxide network used in the anodes of the invention.

Carbon Coating

It is essential that the diatoms used in the anode structure are coated with carbon. The carbon can derive from carbon naturally present in the diatoms or from an external source of carbon or from both. The coating is preferably amorphous carbon formed from an organic carbon-containing precursor such as sucrose, starch or similar. The fact that the coating is amorphous can be seen in XRD and TEM (Transmission Electron Microscopy).

It is preferred if the carbon coating forms 10 to 40 wt % of the diatom/coating structure, preferably 15 to 35 wt %, such as 15 to 25 wt %, ideally 17 to 22 wt % based on the combined weight of calcined diatoms and coating combined. It will be appreciated that the amount of carbon source required to effect a coating level of 20 wt % might be considerably higher than 20 wt % of the precalcined mixture as a carbon source will typically contain non C elements. The person skilled in the art can determined the amount of carbon source required to effect a particular final coating level through an analysis of the carbon content of the source in question.

It is preferred if the carbon coating forms a continuous coating over the nanoporous silicon dioxide diatom structure. The amount of carbon required to form a continuous coating is governed by the porosity of the diatom.

By carbon naturally present within the diatoms is meant carbon sources such as other microorgansims that are inherently present in or perhaps on the diatoms. For example, planckton will grow on the diatoms and are a source of carbon. Other algal sources are a source of carbon, i.e. algae with carbon based cell walls rather than frustules. During calcination, the carbon source is converted to amorphous carbon and non C atoms are liberated.

By an external source of carbon means a carbonaceous material which is added to the diatoms in order to form the coating thereon. The external source might be added instead of or in addition to the natural carbon that is present.

Any carbon source can be used as during the coating procedure. Carbon compounds are generally converted to an amorphous carbon coating during the calcination process. It is preferred if the carbon source is a naturally occurring source such as a saccharides, oligosaccharides or polysaccharides. Preferred sources are cellulosic materials e.g. starch.

The carbon coating increases the conductivity of the material improving therefore the performance of the anode in the battery. In addition, the carbon coating hinders particle growth during calcination and potential particle growth and destruction of the porous network during battery cycling. The carbon coating also aids in the formation of a stable solid electrolyte interface (SEI) layer between the anode and the electrolyte. A SEI is a very thin layer formed on a lithiated anode which develops upon decomposition of the electrolytic solutions. The SEI is composed of organic and inorganic species and forms a layer that is ionically conductive but electronically insulating. It passivates the anode preventing further reactions with the electrolytic solution and allows reversible operation of the device.

It will be appreciated that Li ions present in the electrolyte need to be inserted and de-inserted (extracted) from the anode as the battery charges and discharges. It is vital however, that other components of the electrolyte are not co-intercalated (co-inserted), otherwise the anode is absorbing the wrong material and cannot be acting efficiently. It has been surprisingly found that a carbon coating on the diatoms acts to form a stable SEI layer and hence protects the anode from damage from other components in the electrolyte.

The thickness of the coating on the calcined diatom varies but possible thicknesses are in the sub 10 nm range. Due to thickness variation, the use of wt % to define the amount of coating present is preferred.

### Binder

In order to prepare a composite suitable for the manufacture of an anode of the invention, it is necessary to bind together the calcined diatom material with its carbon coating and the electrically conducting filler such as carbon black conductor particles. The binder may also act as a current collector if it is conductive. Typically, binders do not conduct and hence a separate current collector is required. The binder used in the present invention is water soluble/dispersible.

The term water soluble means a material with a water solubility at 23° C. of at least 1 g/L, It will be appreciated by the skilled man that binders of the invention may derive from natural sources and hence may contain small amounts of non water soluble impurity and so on. Typically these will form less than 2 wt % of any binder used.

Alternatively viewed, the binder is an organic binder, i.e. the binder is derived from a naturally occurring organism such as an algae, crustacean, fungus etc. During the manufacture of the composite, the binder is therefore provided in aqueous form, e.g. a solution, dispersion, suspension or the like. It will be appreciated that there may also be small amounts of organic solvents present as well as water, such as less than 10 wt % organic solvent relative to water. Such solvents will typically be polar, such as alcohols.

The binder of use in the invention is not PVDF based and is not based on any other binder, which is only soluble in NMP. NMP is a volatile, flammable, explosive, reproductive toxicant and it will be clear that avoiding its use is advantageous. It is also expensive. It is currently used as it is the only known solvent that can sufficiently dissolve the PVDF binder without affecting any of the other components of the electrodes. The binder of the invention is introduced using water and not a non aqueous solvent.

The term aqueous based binder implies therefore that the binder used to manufacture the composite of the invention is soluble/dispersible in water. It will be appreciated that once the components of the composite have been blended to form a slurry, they are cast to form a film on a support and then dried. The final composite after drying may therefore contain a de minimis amount of water or no water.

The binder may be provided in an aqueous composition. The relative weight of water to binder may be in the range of 2:1 to 100:1, such as 10:1 to 75:1. The amount of water can vary over a wide range depending on required slurry properties. For example, if we want to increase the viscosity of the slurry we add less solvent to the binder and vice-versa. Obviously, the ratio might depend on the solubility/dispersability of the binder in question.

The binder of use in the present invention is preferably based on a saccharide such as an oligosaccharide or a polysaccharide such as cellulosic material. Binders might therefore be water soluble chitins, alginates, water soluble chitosans etc. Preferred binders are alginates or water soluble chitosans, especially alginates, e.g. sodium alginate. It will be appreciated that aqueous compositions of these types of material might swell.

The alginate binder can be alginate, alginic acid, or a salt of an alginic acid. Further, the salt of the alginic acid can be Na, Li, K, Ca, NH₄, Mg, or Al salt of alginic acid. The alginate-containing composition can have a molecular weight of about 10,000 to about 600,000.

The use of alginate is especially preferred as alginates are obtained from algae. Moreover, the carbon coating on the diatoms is likely to derive from a saccharide structure such as a starch. This means that the two components are inherently compatible. It is important for anode functioning that the binder wets the surface of the carbon coated diatoms and wetting is maximised through the inherent compatibility of the binder materials and the carbon coated diatoms.

The aqueous binder of the invention is non-toxic, environmentally friendly and offers excellent properties, e.g. in terms of cycling properties, stability, longevity and rate capability. The binder may also provide an ideal support for the SEI preventing degradation thereof.

In a further embodiment, in order to maximise the performance of the binder, it is possible to add carbon nanotubes (CNT), other forms of conductive carbon additives, or other conductive additives not comprised of carbon, to the binder. These may form up to 30 wt % of the binder, such as 5 to 20 wt % (calculated on a dry weight basis).

The combination of alginates and CNT is especially preferred and this combination forms a new material for a binder in a LIB. This forms a further aspect of the invention. Thus, viewed from another aspect the invention provides a binder suitable for use in a LIB comprising an alginate and carbon nanotubes.

### Electrically Conducting Filler

The anodes of the invention also contain electrically conducting filler such as carbon black, typically in particulate form. Any conducting filler might be used but the filler is typically carbonaceous, such as carbon nanotubes or preferably carbon black. Carbon black is an electrical conductor and is used to increase the conductivity of the composite electrode, by providing conductive pathways between the silica frustules, and between the silica frustules and the current collector.

The carbon black of the invention may have an arithmetic mean primary particle size of at least 20 nanometres, up to 70 nanometres, when measured using transmission electron microscopy as described in ASTM D 3849-95a, dispersion procedure D.

Further preferably, said carbon black of the invention has a DBP (dibutyl phthalate) absorption number from 80 to 300 cm³/100 g, preferably less than 180 cm³/100 g, when measured according to ASTM D 2414-06a.

Non-limiting examples of carbon blacks of the invention are e.g. carbon blacks grades described with ASTM Nxxx codes, Ensaco black, supplied e.g. by Timcal, Timcal acetylene black, furnace black and Ketjen black. Preferable carbon blacks are Ensaco black supplied e.g. by Timcal, furnace carbon black.

Carbon black (CB) may have a surface area of up to 80 m²/g, when measured according to ASTM D 4820-99 (BET, N₂ adsorption). Surface areas of 30 to 80 g/m² are ideal.

The combination of the calcined carbon coated diatoms, the binder and the filler such as carbon black particles is called a composite herein. This composite is used to form the anode as discussed further below.

The amount of filler such as carbon black present in the composite of the invention is preferably 15 to 50 wt %, such as 25 to 45 wt %, especially 30 to 40 wt % (dry weight).

The amount of binder present in the composite (where the term binder refers to the weight of the dry binder as a whole, e.g. including any CNT if present) is 2.5 to 30 wt %, such as 5.0 to 25 wt %, especially 7.5 to 20 wt %.

The amount of diatoms present in the composite (where the carbon coating forms part of the diatoms) is 30 to 80 wt %, such as 35 to 70 wt % especially 40 to 60 wt % dry weight.

The term dry weight is used to imply that percentages are based on the absence of water. Any water present is to be ignored.

### Process

In order to manufacture an anode of the invention, a source of diatoms is required. Diatoms can be harvested from any source, such as the ocean. Before being used to manufacture the composite of the invention, it is preferred if the diatoms are cleaned or washed. It is possible to dry the harvested diatoms, clean them and dry again or simply clean and then dry following the protocol below. Either process is effective. The cleaning process is however critical for performance as we explain below. Failure to properly clean the diatoms before calcination leads to a reduction in overall capacity.

In an embodiment therefore, the diatom source is firstly dried. Any drying conditions can be used, e.g. reduced pressure, elevated temperature and so on. Ideally, the diatom is subjected to a temperature which is above the boiling point of water so that water is removed. The temperature is not however so high that the diatom is destroyed or so high that carbon naturally present in the diatoms is destroyed. A range of 110 to 200° C. is appropriate, such as 115 to 150° C.

After drying, or after harvesting, depending on the process in question, it is preferred if the diatoms are thoroughly washed. It has been surprisingly found that salts that are present in sea water and hence in the harvested diatoms interfere with the ideal functioning of the anode. Washing thoroughly removes these salts and is therefore an important step. The washing step is therefore one that removes metal salts such as sodium chloride or KCl and any process that removes these salts whilst otherwise not damaging the diatoms is suitable.

For example, washing might take place in a dilute acid. It is also possible that washing takes place in water, e.g. repeated washing in water.

In a preferred embodiment, the amount of water present is diatoms: water (wt %) 1:50 to 1:150, such as 1:70 to 1:100. After initial mixing, the temperature of the water is preferably increased to just below the boiling point of water such as up to 90° C. The temperature can be increased to above the boiling point of water but below 150° C., such as 115 to 140° C. under reflux. The material can be refluxed/held just below boiling for a period of time, e.g. 2 hrs. Thereafter, the material is reduced in temperature to below the boiling point, e.g. 50 to 90° C. The material can be held at this temperature for a prolonged period, e.g. 4 hrs.

The material can then be sieved and washed once more in water and then again under flowing water. The whole procedure can then be repeated.

Once the washing procedure is complete, the resulting diatom product is then dried. The cleaned and dried diatom has a much reduced content of metal salts, such as KCl and NaCl. Whilst before cleaning, the metal salt content of the diatoms may exceed 1.5 wt %, the cleaned material preferably has a metal salt content of less than 1 wt %, ideally less than 0.5 wt %, especially less than 0.1 wt %. The most abundant salts present are KCl and NaCl. More specifically, the cleaned material preferably has a combined KCl and NaCl salt content of less than 1 wt %, ideally less than 0.5 wt %, especially less than 0.1 wt %. Ideally, the diatom is free of any metal salts, in particular KCl and NaCl. By free is meant that the peaks for these materials are not visible on XRD.

At this stage, if the carbon naturally present in the diatom is not being removed, e.g. if no external carbon source is being added, then it is preferred to calcine the dried and washed diatom material. Calcination preferably takes place at a temperature of 400 to 800° C., such as 500 to 750° C., ideally 550 to 700° C., such as about 600° C. or 650° C. The calcination process takes place in an inert atmosphere, i.e. one free of oxygen to prevent any oxidation reactions occurring. Any inert medium might be used such as nitrogen or a noble gas, e.g. Ar.

If calcination is effected at too high temperature then the nanostructure of the frustules can be destroyed. If calcination is effected at too low temperature then the carbon source will not form a coating on the diatoms.

It is also possible to combine the diatoms with an external carbon source at this stage and carry out the calcination process. We describe below the addition of a carbon source and exactly the same principles apply to adding the carbon source at this stage.

After calcination, the resulting material is a porous silicon dioxide structure, e.g. a nanoporous silicon dioxide structure, coated with carbon, ideally amorphous carbon.

In another embodiment, any carbon naturally present can be removed from the diatoms. This allows much better control over how much carbon is present in the final material as the only carbon present would then be that added. After cleaning of the diatoms, rather than calcination, it is preferred to bake the diatoms in the presence of oxygen. The temperature of this baking step is preferably the same as the calcination temperature, e.g. 400 to 800° C., such as 500 to 700° C., ideally about 600° C. In the presence of oxygen, any carbon sources present e.g. plankton are destroyed to leave only the porous silicon dioxide diatom superstructure.

At this point, an external carbon source can be added. Any carbon source might be used but ideally it is a saccharide, oligosaccharide or polysaccharide. The carbon source might therefore contain atoms of C, H and O only. For example, cellulosic materials such as starch type products are suitable. The carbon source can be added on its own or added in a solvent such as water. Thus, an aqueous carbon source can be added to the baked diatoms to provide a source of carbon, which during the subsequent calcination step becomes the desired carbon coating on the diatoms. Thus, after a source of carbon is provided, the diatom/carbon source is calcined as hereinbefore defined.

The calcination step gives rise to a porous carbon coated diatom structure. As a further option, it is possible to use both an external source of carbon and use carbon inherently present in the diatom. Hence a carbon source might be added after the cleaning step but before calcination.

It should be noted that the thickness of the carbon coating on the diatom can be adjusted by varying the amount of carbon source present. Higher amounts of external carbon source lead to thicker coatings. It is preferred if the carbon content is 10 to 35 wt % of the diatom/coating structure, preferably 15 to 25 wt %, ideally 17 to 22 wt % carbon based on the combined weight of diatoms and carbon source.

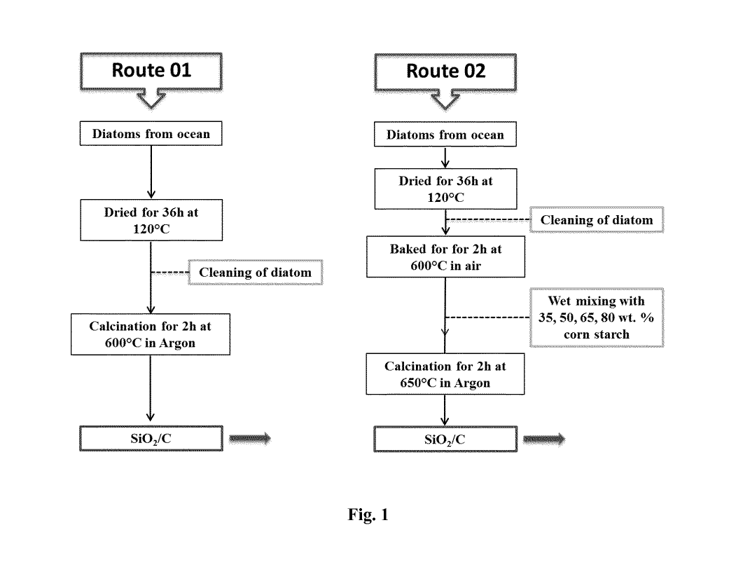

FIG. 1 contains two non-limiting process diagrams showing processes of the invention suitable for producing as carbon coated diatom of the invention.

Thus, viewed from another aspect the invention provides a process for the preparation of a porous carbon coated silicon dioxide network comprising:
(i) obtaining a source of diatoms, e.g. from the ocean and optionally drying the diatoms;
(ii) washing the diatoms and optionally drying the washed diatoms;
(iii) calcining the product of step (ii) in an inert atmosphere at a temperature of 400 to 800° C.

An external carbon source can optionally be added after step (ii).

Viewed from another aspect the invention provides a process for the preparation of a porous carbon coated silicon dioxide network comprising:
(i) obtaining a source of diatoms, e.g. from the ocean and optionally drying the diatoms;
(ii) cleaning the diatoms and optionally drying the cleaned diatoms;
(iii) baking the diatoms of step (ii) in an oxygen containing atmosphere at a temperature of 400 to 800° C.;
(iv) adding a carbon source to the baked diatoms of step (iii);
(v) calcining the product of step (iv) in an inert atmosphere at a temperature of 400 to 800° C.

Once the carbon coated diatom is prepared, it can be combined with filler, e.g. carbon black and the binder to form a composite. The components are mixed, ideally in water to form a slurry. The slurry can be tape cast onto a support, such as a current collector e.g. Cu. The thickness of the film formed can be adjusted to suit the needs of the battery in question but typically it is 10 to 100 microns in thickness such as 50-60 μm. Alternatively viewed, the loading on the support can be 1 to 15 mg/cm², preferably 1 to 10 mg/cm². After drying, this material is then suitable for use as the anode in the battery of the invention.

The invention therefore relates to the use of the composite of the invention as anode in a Li-ion battery as well as to a Li-ion battery comprising a composite as hereinbefore defined.

Lithium-ion batteries using the composite of the invention as an anode are otherwise conventional. They will contain a cathode and an electrolyte, a separator and current collectors as well known. Electrolytes of use include LiPF₆. The cathode is preferably a Li-containing transition metal oxide. Li-based compounds such as LiNi_{1/3}Mn_{1/3}Co_{1/3}O₂ (NMC-111), LiCoO₂ (LCO), LiNi_{0.8}Co_{0.15}Al_{0.05}O₂ (NCA), and LiFePO₄ (LFP) can be used as positive electrode (cathode). A polymer membrane, such as polypropylene membrane is preferably used as a separator and so on. A further discussion of the other conventional features of these batteries is not required.

A further benefit of the invention is that over time, a part of the porous silicon dioxide network that derives from the calcination of the diatoms is reduced to Si. As we noted above, Si is a very interesting anode material in a Li-ion battery as its theoretical performance is so good. It suffers however from a massive expansion problem when absorbing ions. In the present invention, as the battery is used and there are repeated cycles of charge and discharge, the silica is slowly reduced to Si. Due to the relatively small amounts of Si formed overtime (perhaps less than 12 wt % of the overall silica content) and due to the porous structure of the silicon dioxide network, the anodes of the invention can cope with the small amount of expansion that results. We have therefore an anode which contains Si and hence which has excellent performance whilst avoiding the problem of expansion which plagues current Si anode solutions.

The batteries of the invention exhibit valuable properties in terms of capacity. Capacity is the amount of charge that a battery can provide and is expressed as mAh/g. Batteries of the invention may have a capacity of at least 700 mAh/g after 50 cycles of charging and discharging, preferably at least 800 mAh/g. These values are measured at an applied voltage window of 0-2.5V.

It is an important property of the batteries of the invention that no loss of capacity is observed over time (e.g. at least up to 100 cycles). We observe a drop of less than 2% and after repeated cycling. Preferably, we observe an increase in performance due to the formation of limited amounts of Si.

The invention will now be described with reference to the following non limiting examples and figures.

FIG. 1 depicts flow diagrams for the manufacture of the composition of the invention.

FIG. 2 shows X-ray diffraction pattern of diatoms—(a) calcined at 600° C. in argon atmosphere without a cleaning step, (b) calcined at 1000° C. in argon atmosphere without a cleaning step, (c) calcined at 650° C. in air after a washing step, and (d) calcined at 600° C. in argon after a washing step.

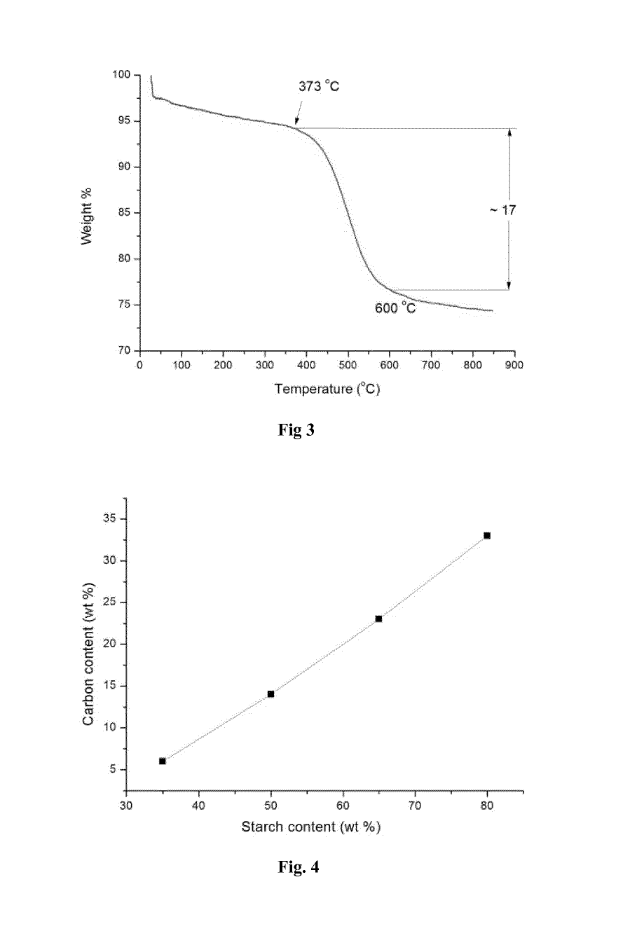

FIG. 3 shows the TG curve of carbon coated diatoms (SiO₂—C).

FIG. 4 depicts the relationship between residual carbon content of diatoms after calcination and added starch content.

FIG. 5 shows FESEM images of carbon coated diatoms (SiO₂—C).

In FIG. 6 shows pore-size distribution and pore surface area of the carbon coated diatom composite (SiO₂—C) measured using mercury intrusion porosimetry (MIP).

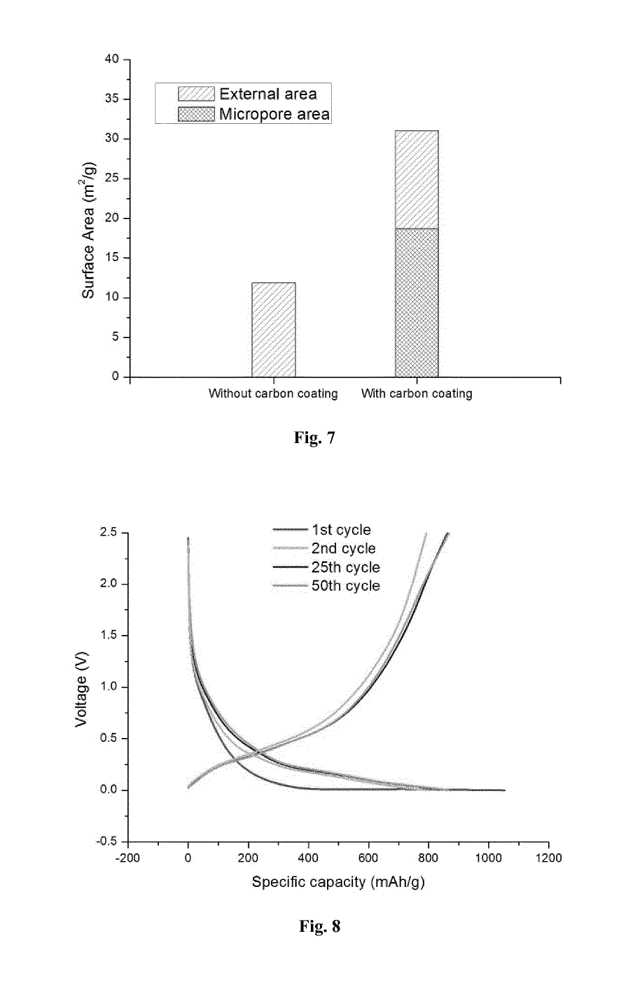

FIG. 7 shows BET surface area including micropore/external surface of washed diatom after calcined at 600° C. for 2 h in air and washed and calcined carbon-coated diatom (SiO₂—C) calcined at 600° C. for 2 h in argon.

FIG. 8 shows galvanostatic charge/discharge profiles of carbon coated diatom-based anodes (SiO₂—C) at 1^{st}, 2^{nd}, 25^{th} and 50^{th} cycles.

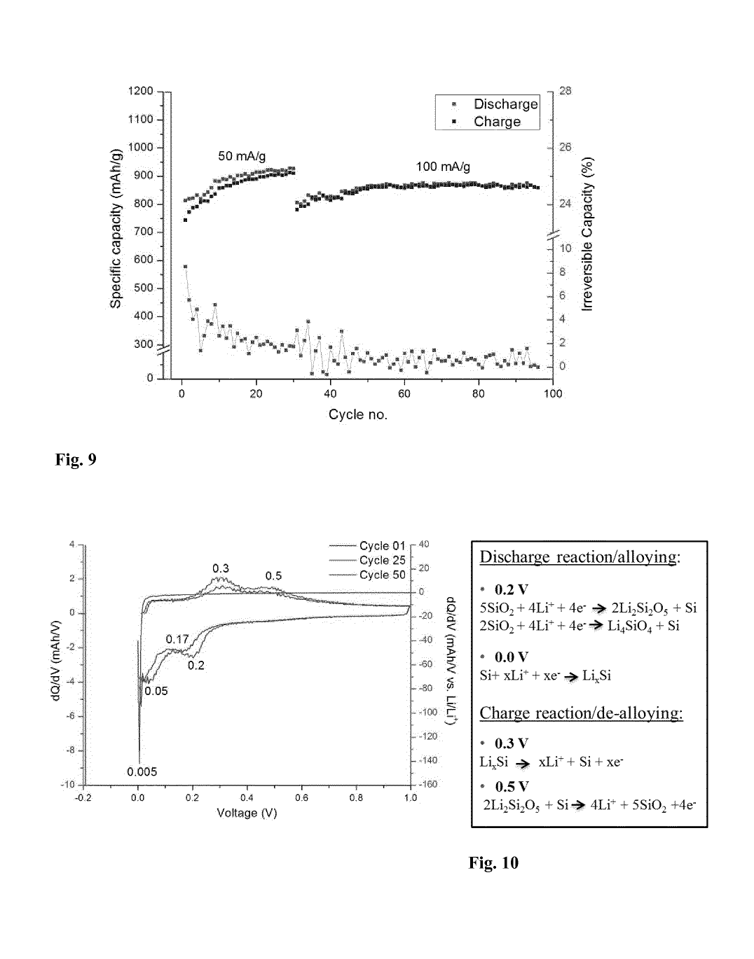

FIG. 9 shows specific capacity and percent of irreversible capacity at current densities of 50 mA/g and 100 mA/g as a function of cycle number for carbon coated diatom-based anode (SiO₂—C).

FIG. 10 shows differential capacity plot of carbon coated diatom-based anode (SiO₂—C) at 1^{st}, 25^{th} and 50^{th} cycles.

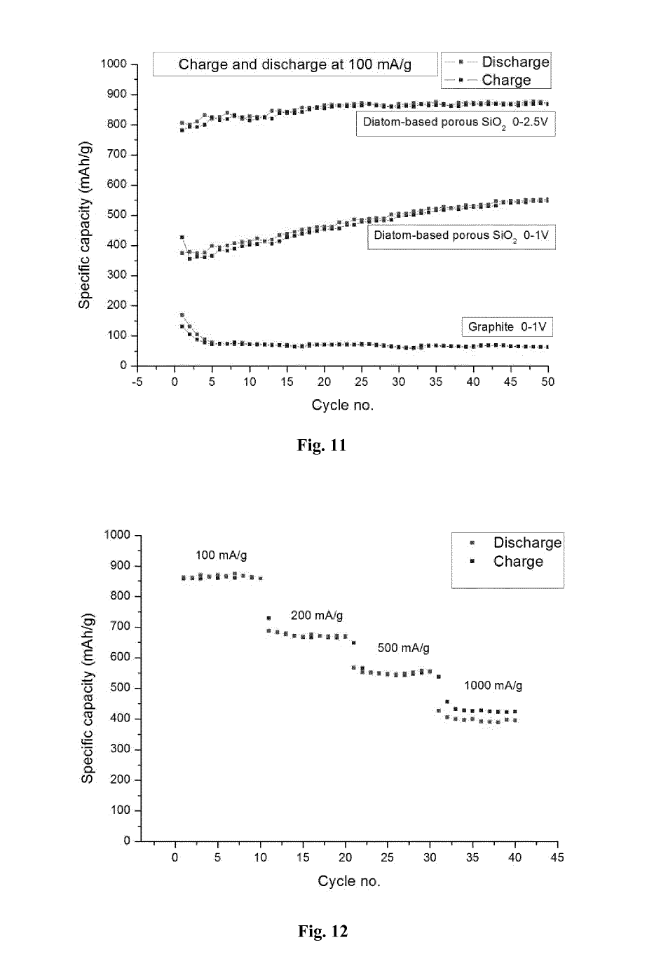

FIG. 11 shows a comparison in terms of specific capacities of carbon coated diatom-based anodes (SiO₂—C) with commercial graphite anode at moderately high current density (100 mA/g) using varied potential windows.

FIG. 12 shows galvanostatic charge/discharge specific capacities of carbon coated diatom-based anodes (SiO₂—C) at different current densities (100, 200, 500, 1000 mA/g).

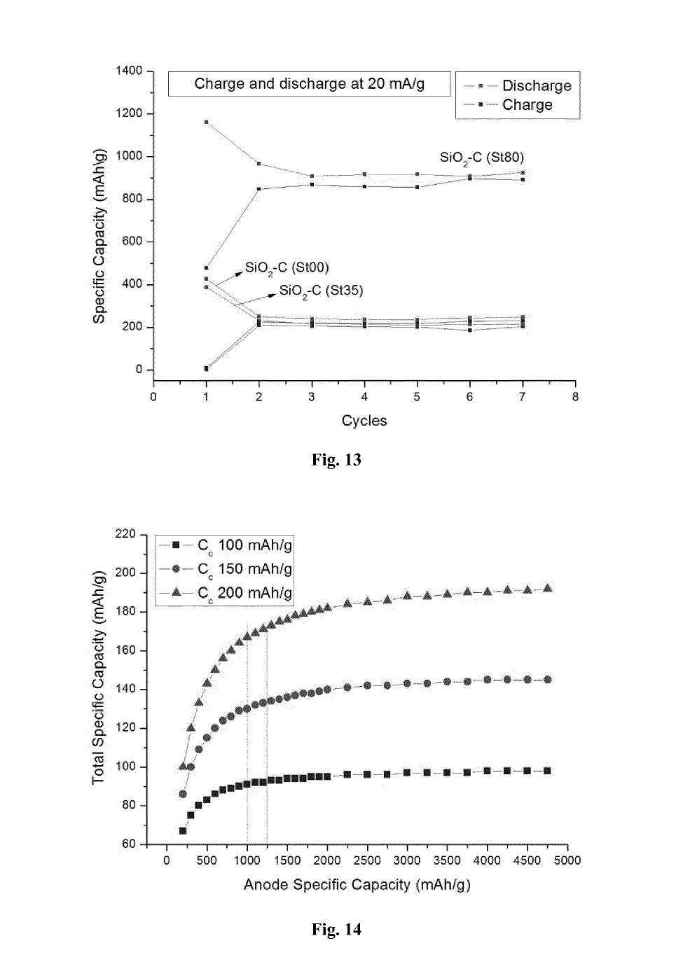

FIG. 13 shows a comparison in terms of specific capacities of carbon-coated diatom-based anodes where carbon coating comes from different amount of starch source (0, 35 and 80 wt. %) at low current density (20 mA/g) using voltage window (0-2.5 V).

FIG. 14 shows total specific capacity of the Li-ion battery as a function of the anode specific capacity (C_{A}). Cathodes with specific capacities 100, 150, and 200 mAh/g are considered.

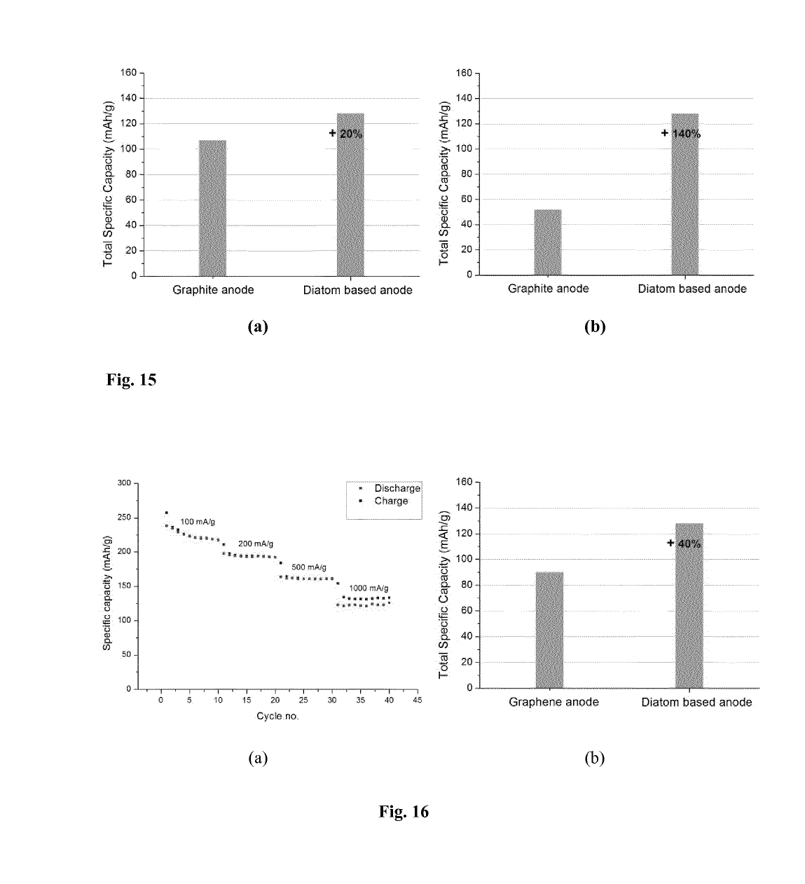

FIG. 15 shows a comparison of total specific capacity of Li-ion battery based on equation 1 when the diatom-based anode (SiO₂—C) and graphite anode are used—(a) considering theoretical specific capacity of graphite (372 mAh/g), and (b) using experimentally measured specific capacity of graphite (80 mAh/g) at current density of 100 mA/g. In both cases (FIG. 15a and FIG. 15b) experimentally measured specific capacity of diatom-based anode (SiO₂—C) (850 mAh/g) at current density 100 mA/g is used.

FIG. 16 shows: (a) Galvanostatic charge/discharge specific capacities of graphene based anodes at different current densities (100, 200, 500, 1000 mA/g), and (b) Comparison of total specific capacity of Li-ion battery based on equation 1 using experimentally measured specific capacity of graphene (225 mAh/g) and diatom-based anode (SiO₂—C) (850 mAh/g) at current density of 100 mA/g.

### EXPERIMENTAL

### EXAMPLE 1

### Preparation of SiO₂—C Composites—a Porous Silicon Dioxide Network with Carbon Coating

Two different routes were used to prepare diatom-based anodes (see FIG. 1). Route 1 was followed to prepare carbon coated SiO₂ composites where organics present in diatoms were utilized to coat the diatoms. Route 2 was followed using a starch as source of carbon which becomes coated on the diatoms during the process. Preparation procedures of both routes are explained below in details.

Route1: Diatoms, a major group of algae which grows a cell wall of silica (SiO₂) called a frustule, were harvested from northern Norwegian Sea by Planktonik As. These frustules (mainly SiO₂) provide a natural nanostructured porous material. The as received diatoms were dried for 36 h at 120° C. Afterwards the dried diatoms were cleaned (procedure provided below) to remove different types of salts present. The diatoms were then calcined at 600° C. for 2 h in argon atmosphere. The organics present in the diatoms worked as source of carbon and provided a coating of carbon on the diatoms. The processed carbon coated SiO₂ composites are denoted as SiO₂—C.

### EXAMPLE 2

Route2: Another batch of composites were prepared by using route two where the cleaned diatom samples were baked at elevated temperature (600° C.) for 2 hours in synthetic air. In this step all organics present with the diatom decomposed and left behind SiO₂-based porous structure. This nano-structured porous diatom (mainly SiO₂) was then mixed with 35-80 wt. % corn-starch as a source of carbon and heat-treated for 2 h at 650° C. in argon filled inert atmosphere. The samples processed following this route are nano-structured porous SiO₂ coated with carbon where the coating thickness and amount depends on the amount of corn-starch mixed as a source of carbon. Both calcination and baking were carried out using a horizontal tube furnace (Carbolite Ltd., Sheffield, UK). The processed carbon coated SiO₂ composites are denoted as SiO₂—C (Stxx). The percentage of starch mixed with SiO₂—C composite is filled in xx place of Stxx (e.g. 50 wt. % starch added composite will be denoted as SiO₂—C (St50)).

### EXAMPLE 3

### Diatom Cleaning Procedure

The dried diatoms were rinsed and put into a large volume of deionized water at room temperature keeping the weight ratio between diatoms and water of 1:70 to 1:100. The temperature of the water increased up to 90° C. under stirring at 400-500 rpm for 2 h. The temperature of the water was reduced to 80° C. for 4 h while keeping the stirring at the same stirring speed. A sieve of mesh size between 32 to 63 μm was used to drain the hot water. Fresh deionized water was added to the sample keeping the weight ratio 1:50 and sonicated for 0.5 h. The diatoms were then washed under flowing water for 5-10 minutes. The process was then repeated. After washing, the samples were dried at 90° C. for 24 h in a drying oven. After removal of the water, the samples were vacuum dried at 150° C. for 18 h. These cleaned diatoms are used for further processing to prepare nano-structured SiO₂-based anodes.

### EXAMPLE 4

### Sodium Alginate Based Aqueous Binder Preparation

The alginate binder is made from sodium salt of alginic acid (Na-Alg), extracted from the cell walls of brown algae. The ratio of Na-Alg (wt. in g), deionized water (volume in ml), and ethanol (volume in ml) was kept 1:60:6. For carbon nanotube (CNT) added binder, the ratio of Na-Alg (consider wt. in g), deionized water (volume in ml), ethanol (volume in ml), and CNT (wt. in g) is 1:60:6:0.2. First, sodium alginate was added to ethanol under stirring. The temperature of the mixture was then slowly increased to 80° C. When the temperature reached 80° C., deionized water was added to the mixture. The temperature was kept at 80° C. for 10 minutes after adding the deionized water. The container is then covered and stirred at 500 rpm at 50° C. for 18 h.

In the case of carbon nanotube (CNT) added binder, CNT is added after this stage. A stirring speed of 500 rpm is maintained while temperature was decreased to 30° C. The stirring stopped when CNT was properly mixed with the alginate binder solution which took approximately 6-8 h.

An ideal mixing method is to sonicate CNT with deionized water for 20-30 minutes for proper dispersion and then add to the solution when the temperature of sodium alginate in ethanol reached 80° C. The temperature was kept at 80° C. for 10 minutes after adding the CNT dispersed in deionized water. The container is then covered and stirred at 500 rpm at 50° C. for 18 h.

### Characterization

The SiO₂—C composite processed from the diatoms was analysed by X-ray diffraction (XRD). A Bruker AXS D8 FOCUS diffractometer equipped with a linear LynxEye PSD detector and Ni-filtered Cu Kα radiation of wavelength 1.5406 Å at 40 kV and 40 mA was used. Scans were recorded with a step size of 0.1° in a range of 20 values from 10 to 80° at scanning speed of 2 sec/step. The specific surface area of the composites was measured by nitrogen adsorption measurements (Tristar 3000 Micrometrics). Samples were degassed for 24 h at 150° C. prior to analysis. 54 and 40 points were measured for the adsorption and desorption isotherms, respectively. T-plot theory based on BET theory was applied for micropore area and the external surface area differentiation. Bulk density, porosity and pore distribution data were acquired by using mercury intrusion porosimetry (Micromeritics, Auto pore IV 9500) over a pressure range of 0.10-60000 psia. A contact angle of 130° was assumed in the pore size calculations. Thermogravimetric analysis (TGA) of the as-prepared SiO₂—C composites were performed with a Netzsch STA 449C Jupiter (Selb, Germany) in synthetic air using a 10° C. min⁻¹ heating rate up to 850° C. The TG curves were recorded in a synthetic air flow of 30 mL min⁻¹. The baseline was subtracted in all cases. The morphology of the products was studied using field emission scanning electron microscopy (FESEM, Zeiss Supra-55 VP).

### EXAMPLE 5

### Anodes

The electrochemical properties of the SiO₂ and SiO₂—C composite were evaluated using CR2016 coin cells assembled in an argon-filled glove box (Labmaster SP, M. Braun GmbH, Germany) where water and oxygen concentrations were 0.1 ppm. The coin cell was composed of lithium as the counter electrode and the working electrode was prepared by mixing 50 wt % of the SiO₂—C composite with 35 wt % Super P carbon black and 15 wt % aqueous binder (alginate based Alg:water=1:60 wt.). Assuming therefore that we target composite material:

SiO2-C composite material 50 wt %=0.30 g

Carbon black=35 wt %=0.21 g

Alginate=15 wt %=0.09 g

Note that the binder solution is formed from binder+solvent and there is 60× as much water as alginate, i.e. =0.09×60=5.4 g of binder solution. High binder content in silicon-based electrodes was recommended for better cyclability. The electrodes were formed by tape casting of the slurry onto battery grade Cu foil (18 μm, Circuit Foil Luxembourg), followed by drying overnight at 90° C. in a vacuum furnace. 25 μm microporous monolayer polypropylene based membrane (Celgard 2500, USA) was used as separator. The electrolyte used was 1 M LiPF6 (Sigma-Aldrich, 99.99%) dissolved in ethylene carbonate/diethyl carbonate (1:1 volume ratio). Charge/discharge analysis was performed galvanostatically between 0 and 2.5 V at room temperature. All reported capacities are quoted with respect to the mass of the SiO₂—C composite.

Results and Discussion

Characterization and Process Development of SiO₂—C Composite

X-ray diffraction of the diatoms (SiO₂) was carried out in different stages of the processing to identify the phases of silica and other minerals present. The XRD pattern of diatoms calcined at 600° C. for 2 h without washing shows peaks which are identified as NaCl and KCl (see FIG. 2a). Sharp peaks appeared when the temperature increased to 1000° C. for 2 h (see FIG. 2b). The diffraction lines at 2θ=21.8°, 28.5°, 36.2° [JCPDS 01-0438, 03-0267] are attributed to cristobalite. However, the cristobalite diffraction lines are absent for diatom samples calcined at 600° C. (see FIG. 2a). FIG. 2c shows the XRD pattern of the washed diatom which is calcined at 650° C. in air. Diffraction lines attributed to crystalline salts (NaCl and KCl) are absent. The cleaning procedure results therefore in the total removal of the salts present before cleaning.

Note that in FIG. 2c, there are no distinct diffraction lines at all as the diatoms are amorphous. The strong signal from the crystalline salts seen in FIG. 2a will mask any contribution from the amorphous silica, which can be seen in FIG. 2c.

All organics burned-off at this high calcination temperature and only nano-structured silica remains. The spectrum is centered at about 2θ=22° which is characteristic of amorphous silica. The smoothness of the pattern also indicates that the cleaning process with multiple washing efficiently removes the NaCl and KCl salts trapped in the porous structure of diatoms.

FIG. 2d shows the XRD pattern of carbon-coated diatoms (SiO₂—C). The cleaning step only removes the salts, and the organics present in the diatoms are utilized to coat the diatoms. The wide features appearing in FIG. 2d indicates that both the carbon layer and the diatoms (SiO₂) are amorphous and also confirms the absence of other crystalline impurities in the carbon-coated diatoms (SiO₂—C).

Thermogravimetric Analysis (TGA)

Thermogravimetric analysis was used to measure the content of carbon coated on the diatoms (SiO₂—C and SiO₂—C (Stxx) composites). FIG. 3 shows thermogravimetric curve obtained for SiO₂—C composite where the remnant organics in the diatoms were used as source of carbon to provide a coat. A one-step feature is identified from the TGA curve. Initially the small loss in weight below 200° C. is due to the desorption of residual water vapour and evaporation of any gaseous content.

The carbon content of SiO₂—C is obtained with an assumption that the weight loss in between 375-600° C. is caused by carbon oxidising to CO and CO₂ in a fixed flow rate of oxygen. A weight loss of around 17 wt % of carbon is measured for SiO₂—C composites.

For composite SiO₂—C (Stxx), corn-starch is used as source of carbon to coat organic-free diatoms. The starch content used to prepare the sample varied between 35-80 wt %. A linear relationship is observed between the measured carbon content and the amount of corn-starch used (see FIG. 4). It is thus possible to estimate the amount of corn-starch required to provide a certain amount of carbon-coating on the diatoms.

Morphology

Classical micro and nano-scale microstructures of carbon coated diatoms (SiO₂—C) with varying pore-size distribution in a repeated manner were observed in field emission scanning electron microscopy (FESEM). The porous morphology observed has a long range order, with a very narrow pore size distribution (see FIG. 5). Diatoms are divided in more than 200 families. From FIGS. 5(a,b, and c), it is clear that the diatoms hauled from northern Norwegian Sea are disc-shaped and identified as coscinodiscus in the family of coscinodiscaceae. This type of diatoms are usually regarded as one of the largest marine diatom genera. Repeated valves of various shapes and sizes were observed FIG. 5(d-o). The pore size and pore-distribution in the carbon coated diatoms (SiO₂—C) were studied in more detail by mercury intrusion porosimetry.

Porosity, pore-size distribution, and pore surface area of the carbon coated diatom composite (SiO₂—C) were measured using mercury intrusion porosimetry (MIP). In FIG. 6, the x-axis represents the pore diameter on a log scale. The y-axis (dV/d log P) represents the change in volume of intruded mercury with respect to the log of pressure required to force mercury into the pores. The red line shows the cumulative pore area; a gradual uptake of mercury followed by a sharp uptake, as a large number of pores are filled at once. As can be seen from FIG. 6, multiple peaks are present in between 50-600 nm range and pore-size distribution is very narrow for each peak. These peaks correspond to meso- and macro-pores and contributed more to the surface area. As the pore size increases, the surface area decreases. Small pores make a greater contribution to the surface area, compared to larger ones. It is worth noting that a sharp large peak at around 50 nm corresponds uptake of a greater amount of mercury and contributes significantly to the surface area. Therefore inference can be made based on the peak shapes that a significant number of pores in the diatoms are in 50-80 nm size range, whereas other pores lie in 200-600 nm size range. The results obtained from mercury intrusion porosimetry also supported by the morphological study made by field emission scanning electron microscopy (see FIG. 5).

Surface area and porosity of the carbon-coated (SiO₂—C) and without coated diatoms (SiO₂) were measured by nitrogen adsorption based BET analysis. BET is best suited to studies of micro (<2 nm) and meso (2-50 nm) pores. Depending on the material, it can be challenging to generate comprehensive data for distribution of pores>100 nm. On the other hand, nitrogen adsorption can provide valuable information on micropores resulting from the amorphous carbon coating. As expected, no micropore area was detected for samples without carbon coating. However, the external surface area was about 12 m²/g. For carbon-coated diatom (SiO₂—C) samples the micropore and external surface area were detected as 19 m²/g and 12 m²/g, respectively. Whereas the pore surface area measured by mercury porosimetry for the same sample was about 10 m²/g. The pore surface area value generated by porosimetry is generally found to agree with gas adsorption when there are no very small pores present, i.e. <10 nm. When these pores are present, they are outside of the porosimetry measurement range and the surface area value is therefore artificially low. The external surface area for both coated and non-coated diatoms was found to be equal, which consolidates the assumption that carbon-coating generates micropores in diatom based samples.

Galvanostatic Cycling

The electrochemical behaviour of all anodes in this work during charging and discharging is investigated in a two-electrode coin cell (half-cell) set-up where diatom based composites are used as electrode material and lithium foil as counter electrode. Therefore, the term charge indicates de-alloying and discharge as alloying for diatom based electrodes in use. FIG. 8 shows the cycling potential window (0-2.5 V) versus charge/discharge specific capacities of 50 wt. % carbon-coated diatom based composite (SiO₂—C) electrode at a current density of 50 mA/g. It delivers a specific capacity of 1050 mAh/g in its first discharge cycle (alloying). In the second cycle the capacity dropped to 800 mAh/g and started increasing in consecutive cycles. It reached to 875 mAh/g in its 50^{th} cycle. However, the specific capacity during charge also increases from the second cycle (800 mAh/g) to the 50^{th} (865 mAh/g). The irreversible capacity loss in the first cycle is attributed to more Li⁺ ions trapped inside the pores of the diatoms or consumed in the solid-electrolyte-interface (SEI) formation. From the pattern of the charge curve (see FIG. 8), it is also apparent that the de-alloying mostly took place at potentials<0.5 V and alloying at potentials<0.25 V (vs. Li/Li⁺).

A galvanostatic charge/discharge cycle of the carbon-coated diatom based composite (SiO₂—C) electrode was carried out at a current density of 50 mA/g (1-30 cycles) and 100 mA/g (31-96 cycles). The capacity increases steadily until it stabilizes at around 50 cycles (see FIG. 9). The increment of capacity is noticed for both current rates and is more prominent during the initial 20 cycles. It is believed that this capacity increase is due to the increasing amount of silicon (Si) phase as silica (SiO₂) is partially reduced by Li and capacity increases over time as more silicon is converted from silica. A differential capacity against voltage curve is shown in FIG. 10 for different cycles measured at a current density of 100 mA/g. The phenomenon is well established that SiO₂ is reduced to Si or crystalline Li₄SiO₄ during the initial discharge (alloying) below 0.24 V. The reduced Si further reacts with lithium ions to form LiₓSi alloys as the potential reached close to 0.0 V. The formation of a Li₄SiO₄ phase during cycling is irreversible. During the initial few cycles a surge in capacity is observed due to the capacity gained by inclusion of the new Si phase in the structure which outweighs the irreversible formation of the Li₄SiO₄ phase. A noticeable peak is observed during the charge cycle at around 0.3 V, which can be attributed to de-alloying of the LiₓSi phase. The sharpening and growth of de-alloying peak indicates enhanced kinetic of de-lithiation as the cycle number increases.

The irreversible capacity loss as shown in FIG. 9 decreases with further cycling and remain stable below 1%. This irreversible capacity is inversely proportional to the coulombic efficiency. Therefore, it can also be stated that the coulombic efficiency increases with cycle number which is in good agreement with the differential capacity curve in FIG. 10.

A comparison of galvanostatic charge/discharge cycles between carbon-coated diatom based composite (SiO₂—C) and graphite for 50 cycles at current density of 100 mA/g in two different potential windows is shown in FIG. 11. A stable specific capacity of more than 850 mAh/g is obtained with the carbon-coated diatom based composite (SiO₂—C) when the potential window was kept between 0-2.5 V. Since conventional graphite electrodes operate at potential only 150 mV higher than the lithium metal, 0-2.5 V is way too high for graphite as an active potential window. Therefore, a lower potential window (0-1 V) is considered more realistic to compare their capacity values. It is apparent that the carbon-coated diatom based composite (SiO₂—C) delivered a stable specific capacity of around 550 mAh/g, while the stable specific capacity for graphite based electrode, given the same cycling conditions, was found to be around 70 mAh/g. A direct quantitative comparison cannot be derived from the results obtained due to the difference in the active material mass in the two electrodes. However, it is apparent that the specific capacity of the carbon-coated diatom based composite (SiO₂—C) is four to five times that of graphite under the stated conditions, even if the equal active mass was considered in the calculation.

The rate capability of the carbon coated diatom-based anodes (SiO₂—C) is illustrated in FIG. 12 at various current densities (100, 200, 500, 1000 mA/g). As the current density increases, the specific capacity declines. At high current density (1000 mA/g), unlike others, the charge (de-alloying) specific capacity became apparently greater than discharge (alloying) specific capacity (see FIG. 12). This certain behaviour at higher current rates can be explained by the resistance of the solid-electrolyte-interface (SEI). The SEI formed during the 1^{st} cycle has a certain resistance for allowing lithium ions to pass through. If the discharge (alloying) current exceeds a certain limit a voltage drop occurs across the SEI and results in lithium ion deposition on the SEI rather than allowing it to pass through [(McDowall 2008)]. This lithium plating damages the cell and reduces its cycle life. Therefore, a maximum discharge (alloying) current should be defined to prevent damage and reduction of capacity.

According to the results obtained from the carbon-coated diatom based anodes, where the carbon coating comes from different amount of starch (0, 35 and 80 wt. %), it is clearly seen that cycle performance improved with increase of carbon content (see FIG. 13). For the composite SiO₂—C (St80), the thick carbon (˜30 wt. %) layer provided proper interconnected electrical conductivity and also a stable structure to buffer the high volume change during cycling. It was determined by thermogravimetric analysis, shown in FIG. 4, that 35 wt. % of starch provides only ˜6 wt. % of carbon, which is inadequate to serve the purpose of proving a complete carbon-coating. Thus, the charge and discharge specific capacities of both SiO₂—C (St35) and SiO₂ (St00) are almost identical and follow similar trends. The slightly higher capacity of SiO₂ (St00) compared to the SiO₂—C (St35) composite is due to more active material present. The results obtained also demonstrate that the interfacial resistance of the electrode particles significantly contributed to the electrode resistance. Therefore it is important to have a carbon-coating of a certain thickness in order to utilize its advantage to improve the electrode conductivity.

Full-Cell Analogy

Despite worldwide research efforts, the specific capacity of commercially used cathodes, are unable to exceed values of 200 mAh/g, while most lie below 150 mAh/g. On the other hand, the practical value of the carbonaceous anode has recently reached the theoretical value of composition LiC₆. However, these carbonaceous anodes showed deteriorated value when high current densities are used due its inability to allow high lithium ion diffusion rates. Thus, in order to increase the total cell capacity of the electrode material (cathode+anode) higher capacity anode materials is the only solution at present. A classic relationship between the total cell specific capacity as a function of anode specific capacity is shown by Yoshio et al. [(Yoshio, Tsumura et al. 2005)], where the total cell specific capacity varies with the anode's specific capacity (C_{A}) when the cathode's specific capacity (C_{C}) is considered as constant:

$$\begin{matrix}Total specific capacity = \frac{{C}_{C}}{1 + \frac{{C}_{C}}{{C}_{A}}} = \frac{{C}_{A} {C}_{C}}{{C}_{A} + {C}_{C}} & ( mAh \text{/} g )\end{matrix} \qquad ( 1 )$$

Using the above equation (Eqn. 1), FIG. 14 has been created where cathodes of three different capacities—100, 150, and 200 mAh/g are considered. Two regions are clearly discernable—a faster rate of increase of total capacity in the beginning with increasing anode capacity and later it flattened out when the anode's capacity exceed a certain value. An optimized capacity of the anode is thus identified in the region between 1000-1250 mAh/g, which would provide the best value for the total cell. It was shown earlier in FIG. 8 that the nano-structed carbon coated diatoms (SiO₂—C) provide a capacity of 850 mAh/g when galvanostatically cycled at a current density of 100 mA/g. However, the capacity is more than 900 mAh/g when cycled at lower current densities, e.g. 50 mAh/g.

The comparison of total cell capacity increment is shown in FIG. 15 where cathode capacity is fixed at 150 mAh/g and anode capacity varies with the graphite based anode and diatom based anode. FIG. 15a shows the comparison of total cell capacity increment by 20% considering the theoretical capacity of the graphite anode (372 mAh/g) and experimental capacity of the diatom based anode (850 mAh/g) measured at 100 mA/g current density. It has been observed that the graphite based anode is unable to retain its capacity when higher current density is used due to slow lithium ion diffusion rates. This behaviour of graphitic anode is in good agreement with the findings of Zaghib et al. [(Zaghib, Brochu et al. 2001)] where they found a sluggish solid-state diffusion of lithium ions at increased current rate. This slow diffusion of lithium ions ultimately limits the intercalation capacity in graphite. Thus, it would be more pragmatic to compare the value when both capacity values are experimentally measured. Therefore, the total cell capacity is calculated based on the capacity of commercially procured graphite anode (80 mAh/g) and the capacity of the diatom based anode (850 mAh/g) measured at 100 mA/g current density in half-cell geometry are shown FIG. 15b. Comparing the specific capacity of graphite and diatom based anodes at higher current rates, the full cell capacity can be increased by 20-140% when diatom based anodes are used.

Graphene, a high capacity carbonaceous anode, was also used to compare the total cell capacity with the diatom based anode (SiO₂—C). Graphene was prepared in-house from natural graphite using Hummers method [(Hummers and Offeman 1958)]. After formation of graphite oxide, a heat-treatment process at low temperature (0.3 h at 170° C.) and high temperature (2 h at 800° C.) was carried out to achieve the final form as graphene. The theoretical capacity of graphene varied between 780 and 1116 mAh/g based on Li ion absorption as Li₂C₆ or Li₃C₆ respectively [(Hou, Shao et al. 2011)], (Hwang, Koo et al. 2013)]. At very low current density, in this case 20 mA/g, graphene-made cells reached specific capacity of about 824 mAh/g. However, with increasing current density graphene also behaves similar to graphite and its capacity deteriorated drastically. Galvanostatic charge/discharge specific capacities of graphene-based anodes at different current densities (100, 200, 500, 1000 mA/g) is shown in FIG. 16a. At 100 mA/g current density, the graphene based anode showed a stable specific capacity of 225 mAh/g, whereas the specific capacity of the diatom based anode was measured at 850 mAh/g. When cathode capacity is fixed at 150 mAh/g, the full cell capacity can in theory be increased by more than 40% when the diatom based anodes are used (see FIG. 16b).

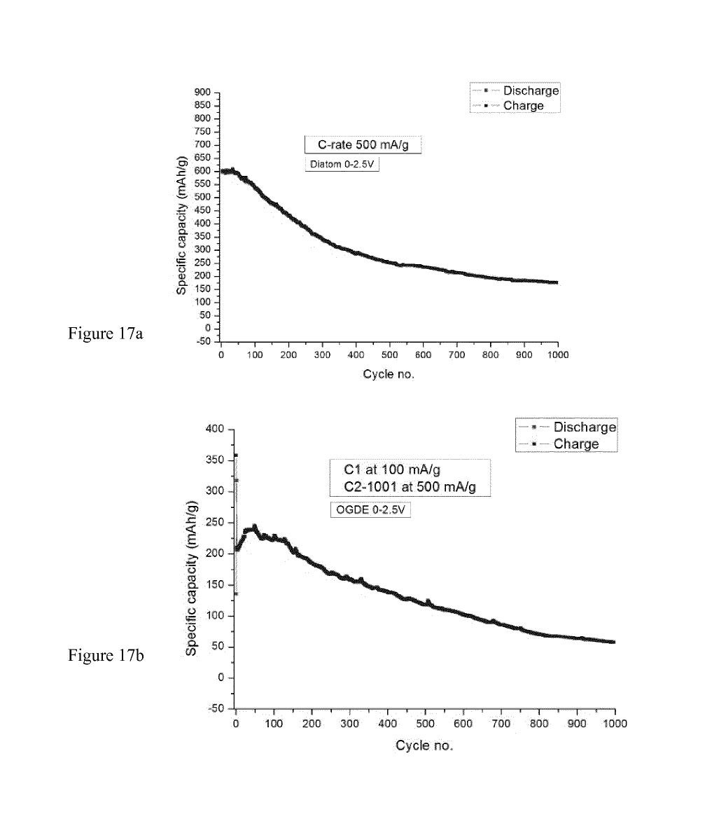

FIGS. 17a and 17b describe long term cycling of half cells (silica anode vs Li counter electrode).

Both of these figures show batteries (half cells with Li metal as counter electrode) that have been cycled 1000 times at high charge/discharge rate. It shows that the batteries do degrade at this C-rate, but a battery will never be subjected to this high C-rate for long periods of time when in normal use. A C-rate of 500 mA/g is a very high discharge rate. In most types of electronic applications where Li-ion batteries are used, a C-rate of 500 mA/g would never be required. It is known that batteries degrade faster when high discharge rates are used, while they would last longer for slower discharge rates.

In FIG. 17a, the electrode is diatoms coated with carbon and mixed with carbon black and the Na-alginate binder (using water as solvent). In FIG. 17b, the electrode is diatomaceous earth coated with carbon and mixed with carbon black and the Na-alginate binder (using water as solvent). Diatomaceous earth is another type of amorphous silica which is commercially available, but does not have the favorable morphology that the diatoms do. We have included this figure to show the advantage of using the particular morphology that the diatoms provide.

Explanation of Legends

C-rate refers to the rate of discharge in units of mA/g

OGDE (FIG. 17b) is short for organic grade diatomaceous earth

C1 refers to the first charge/discharge cycle, while C2-1001 refers to the next 1000 cycles. So this means that the first cycle is performed at a charge/discharge rate (C-rate) of 100 mA/g, while the following 1000 cycles is run at 500 mA/g

Diatom 0-2.5V means that the diatom electrode has been cycled between 0 V and 2.5 V. Likewise with the OGDE, they have been cycled between 0 and 2.5 V.

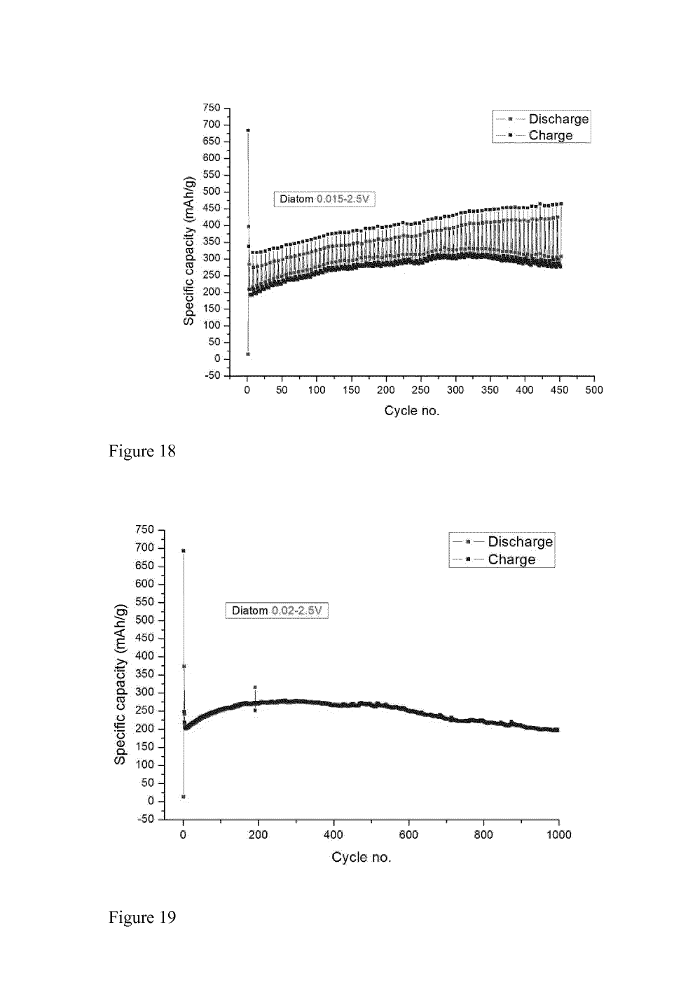

FIG. 18 shows a half cell which has been cycled every other cycle at high and low discharge rates. This figure uses an alternate C rate (50 mA/g and 500 mA/g). This more closely resembles the use of a battery in a real life application. So here, the half cell with diatoms is charged and discharged first at 20 mA/g for the very first cycle. Then for the remaining cycles the charge/discharge rate is alternated between 50 mA/g and 500 mA/g. So the upper row of squares represent charge and discharge at 20 mA/g, respectively. While the lower set of squares represent the charge and discharge at 500 mA/g, respectively. The electrode here is the same as previously: diatoms coated with carbon and mixed with carbon black and Na-alginate binder using water as solvent. The electrode has been cycled between 0.015 V and 2.5 V.

In FIG. 19 the electrode is the same as before: diatoms coated with carbon and mixed with carbon black and Na-alginate using water as solvent. Here the half cell has been cycled in a slightly narrower potential window: 0.02 V to 2.5 V. The first cycle is run at 20 mA/g while the following cycles are performed at 500 mA/g. In addition, 10% FEC (fluoroethylene carbonate) has been added to the electrolyte. This is a common additive in battery electrolytes, which promotes stability. This is also evident here, as we don't see the degradation observed (i.e. FIG. 17a) when FEC is not used.

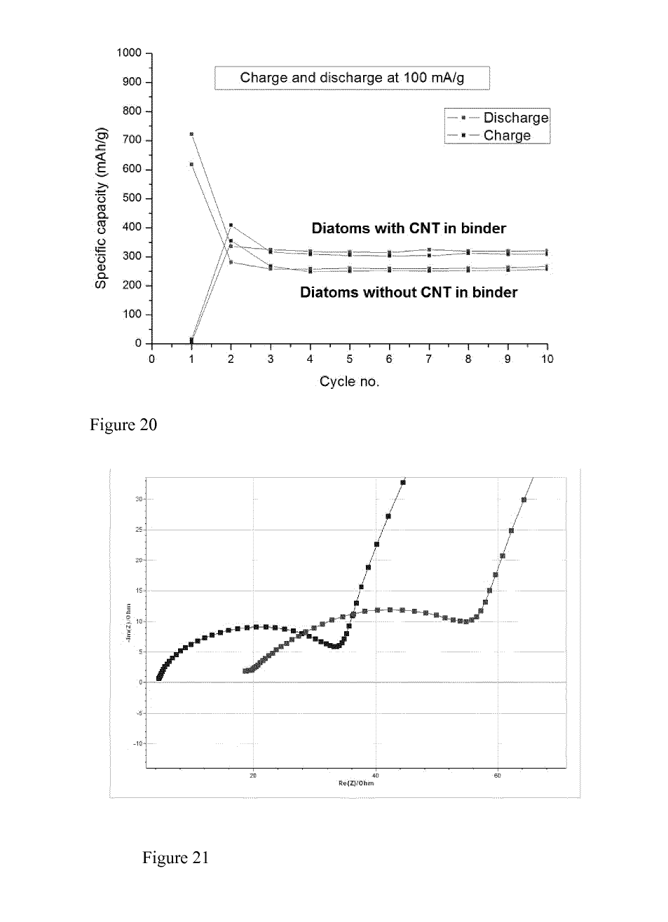

FIG. 20 shows charge/discharge data for two half cells, one which has been cycled with CNT as conductive additive in the binder, and one which has been cycled with Na-alginate binder without CNT. Cell with CNT: diatoms coated with carbon mixed with carbon black and Na-alginate binder with CNT, dissolved in water. Cell without CNT: diatoms coated with carbon mixed with carbon black and Na-alginate binder, dissolved in water. The upper two lines are the charge (blue) and discharge (red) for the cell with CNT in the binder. The lower two lines are for the cell with just the plain Na-alginate binder. This shows an increase from about 250 mAh/g to over 300 mAh/g when carbon black is replaced by CNT. Both cells are cycled at 100 mA/g.

In FIG. 21, Nyquist plots of both cells are shown. Nyquist plots show impedance data for the cells which shows that the resistance is much lower for the cells with CNT. The blue line shows the cell with CNT. The value on the x-axis shows the resistance in Ohms. By extending the blue and red semi-circles to the x-axis, we can see that the resistance of the cell with CNT is just under 40 Ohms, while the cell with no CNT in the binder has a resistance of more than 60 Ohms. Lower internal resistance will improve capacity both at high and low C-rates.

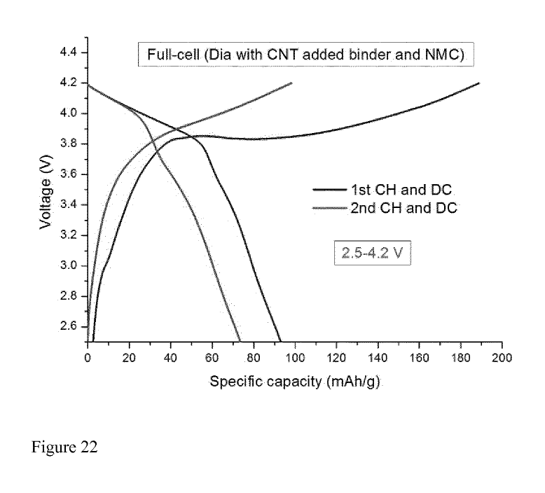

Results of full cell testing are shown in FIG. 22. This figure shows results of a full cell battery where commercial NMC [Li(Ni,Mn,Co)O₂] is used as cathode and diatoms with CNT added to the binder as anode. The data shows that the diatoms do indeed work in a full cell configuration. The blue lines show the first charge and discharge of the cell, while the red lines show the second charge and discharge cycle. The cell is cycled between 2.5 and 4.2 V. Composition of the anode: diatoms coated with carbon, carbon black, Na-alginate binder with CNT, water as solvent Cathode is made according to conventional standards with carbon black as conductive additive and PVDF as binder, NMP is used as solvent.

Conclusions

Upon extended cycling the reversible capacity of the carbon coated diatoms (SiO₂—C) starts to increase from approximately the fourth cycle due to chemical reactions causing a Si phase to appear. The porous morphology and natural nano-structure of the carbon coated diatom-based anode can accommodate the volume expansion associated with Si and preserve the solid electrolyte interface layer. Specific discharge capacities of these diatom-based anodes are more than two times the value of the existing theoretical capacity of graphite based anodes. The high reversible capacity, good cycle performance and simple processing of these electrodes make the diatoms a potential environmentally friendly high capacity anode material for lithium-ion batteries.

1-19. (canceled)

20. A composite comprising:
a coated silicon dioxide network comprising (a) a porous silicon dioxide network coated in a carbon coating, or (b) a calcined diatom silicon dioxide network coated in a carbon coating;
an electrically conducting filler; and
a water dispersible or water soluble binder.

21. The composite of claim 20, wherein the coated silicon dioxide network comprises a porous silicon dioxide network coated in a carbon coating.

22. The composite of claim 20, wherein the coated silicon dioxide network comprises a calcined diatom silicon dioxide network coated in a carbon coating.

23. The composite of claim 20, wherein the electrically conducting filler comprises carbon black.

24. The composite of claim 20, wherein the water dispersible or water soluble binder comprises an alginate.

25. The composite of claim 20, wherein the water dispersible or water soluble binder comprises carbon nanotubes.

26. The composite of claim 20, wherein the carbon coating comprises less than 1 wt % KCl and/or NaCl.

27. The composite of claim 20, comprising 10 to 40 wt % carbon coating in the coated silicon dioxide network, based on the weight of the coated silicon dioxide network.

28. The composite of claim 20, comprising 15 to 50 wt % of said electrically conducting filler.

29. The composite of claim 20, comprising 5 to 30 wt % of the water dispersible or water soluble binder.

30. The composite of claim 20, comprising 30 to 80 wt % of the coated silicon dioxide network; 15 to 50 wt % of the electrically conducting filler; and 2.5 to 30 wt % of the water dispersible or water soluble binder.

31. The composite of claim 20, wherein 30 to 80 wt % of the porous silicon dioxide network or the calcined silicon dioxide network is coated in the carbon coating.

32. An anode for a lithium-ion battery, the anode comprising a composite according to claim 20.

33. A lithium-ion battery having at least the anode, a cathode, and an electrolyte, wherein the anode comprises the composite according to claim 20.

34. The lithium-ion battery of claim 33, having a capacity of at least 700 mAh/g after 50 cycles of charging and discharging.

35. A process for preparing a composite according to claim 22, comprising:
calcining a diatom source in the presence of a carbon source to obtain a calcined diatom network coated in carbon; and
combining said calcined diatom network with an electrically conducting filler and a water dispersible or water soluble binder.

36. A porous silicon dioxide network coated in a carbon coating, said porous silicon dioxide network coated in a carbon coating comprising less than 1 wt % combined weight of KCl and NaCl.

37. A process for preparation of a porous carbon coated silicon dioxide network, the process comprising:
(i) obtaining diatoms from a source of diatoms, and optionally drying the diatoms;
(ii) cleaning the diatoms, and optionally drying the cleaned diatoms;
(iii) baking the diatoms of step (ii) in an oxygen containing atmosphere at a temperature of 400 to 800° C.;
(iv) adding a carbon source to the baked diatoms of step (iii); and
(v) calcining the product of step (iv) in an inert atmosphere at a temperature of 400 to 800° C.
